(19) United States
(12) Patent Application Publication
(10) Pub. No.: US 2009/0180077 A1
(43) Pub. Date: Jul. 16, 2009

(54) REAR PROJECTION SCREEN BASED ELECTRONIC WINDOW

(75) Inventors: Adrianus J.S.M. De Vaan, 'S-Hertogenbosch (NL); Eelco G. Visser, Best (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,828

(22) PCT Filed: Sep. 15, 2005
(86) PCT No.: PCT/IB05/53037

§ 371 Date: Mar. 22, 2007

Related U.S. Application Data
(60) Provisional application No. 60/612,037, filed on Sep. 22, 2004.

(51) Int. Cl. G03B 21/26; G03B 21/62

(52) U.S. Cl. 353/30; 359/457

(57) ABSTRACT

An electronic window (20) employs a rear projection screen, a rear projection engine (21), and a solar simulator (22). Rear projection engine (21) is positioned at a first location relative to the rear projection screen wherein rear projection engine (21) is operated to project an image onto the rear projection screen. Solar simulator (22) is positioned at a second location relative to the rear projection screen wherein solar simulator (22) is operated to simulate a sunbeam shining through the rear projection screen.

The present invention generally relates to electronic windows. The present invention specifically relates to an electronic window displaying an image for viewers within a dim environmental setting (e.g., a hospital room, a hotel room, an indoor shop, a work cubical, etc.) while simulating a sunbeam shining through the electronic window into the dim environmental setting.

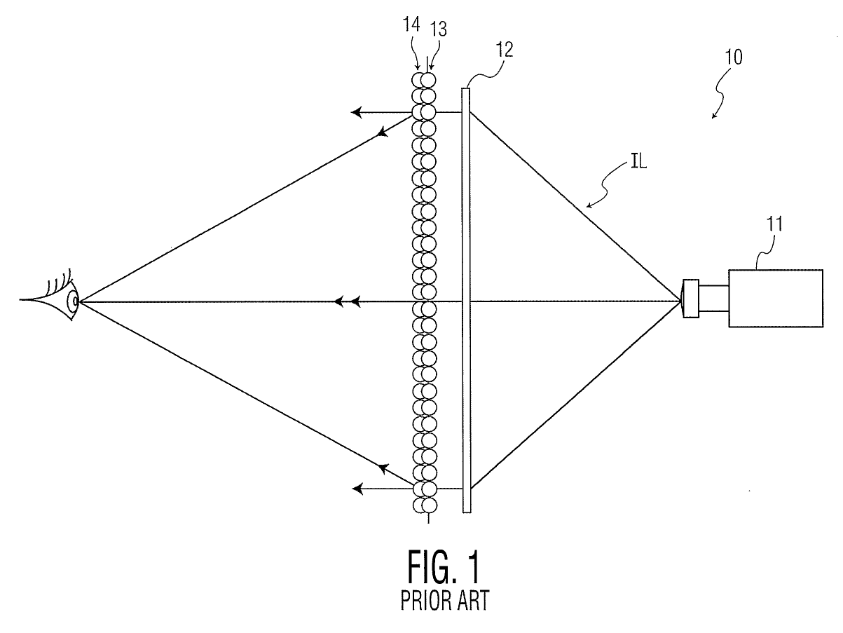

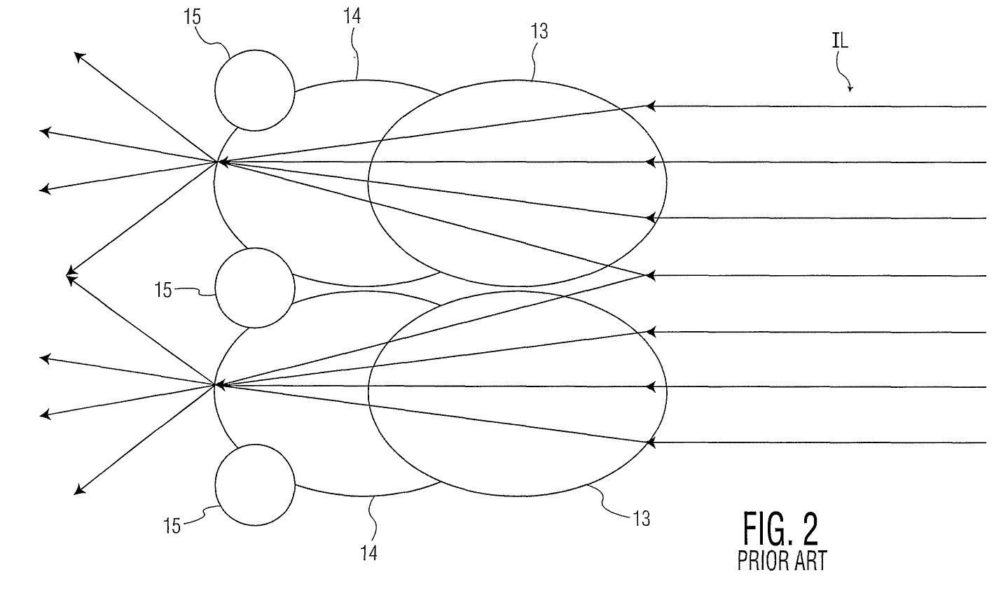

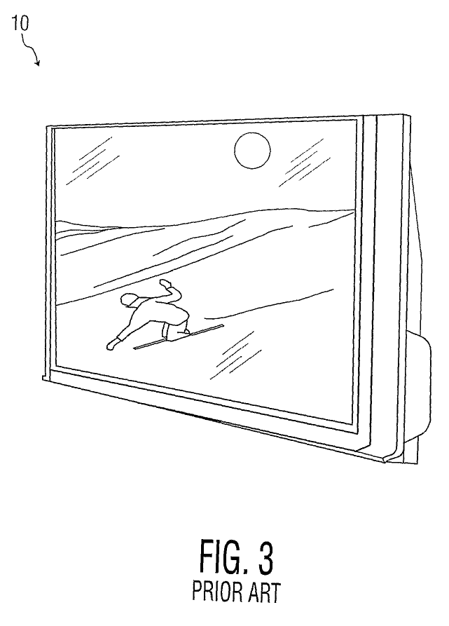

FIG. 1 illustrates an exemplary image projection by a known rear projection display system 10 employing a rear projection engine 11 and a rear projection screen primarily defined by a Fresnel lens 12, light-incident-side lenticular lens 13, and light-emitting lenticular lens 14. Lens 13 and lens 14 are paired whereby each pair share the same optical axis as exemplary shown with the two pairs of lens 13 and 14 illustrated in FIG. 2. In operation, image light IL projected by engine 11 is incident onto Fresnel Lens 12, which collimates and projects the image light IL incident upon lens 13. Lens 14 conventionally includes diffusing micro particles (not shown) whereby lens 13 directs the image light IL toward the diffusing micro particles whereby a resulting image is optimally distributed within an environmental setting. Lens 14 also conventionally includes black stripes 15 to minimize, if not eliminate, any reflection of ambient light reflecting upon the rear projection screen. The result is a display of the image as exemplary shown in FIG. 3 for viewers within the environmental setting of system 10.

The lighting industry is continually striving to increase the illumination within dim environmental settings (e.g., a hospital room, a hotel room, an indoor shop, a work cubical, etc.) to improve upon the human experience with such dim environment al settings. To this end, the present invention provides new and unique structural configurations of rear projection display systems to define an electronic window for displaying an image within a dim environmental setting while simulating a sunbeam shining through the electronic window into the dim environmental setting.

One form of the present invention is an electronic window employing a rear projection screen, a rear projection engine, and a solar simulator. The rear projection engine is positioned at a first location relative to the rear projection screen wherein the rear projection engine is operable to project an image onto the rear projection screen. The solar simulator is positioned at a second location relative to the rear projection screen wherein the solar simulator is operable to simulate a sunbeam shining through the rear projection screen.

The foregoing form as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

FIG. 1 illustrates an exemplary image projection by a rear projection display system as known in the art;

FIG. 2 illustrates an exemplary image diffusion by a lenticular screen of the FIG. I rear projection display system;

FIG. 3 illustrates an exemplary image display by the FIG. 1 rear projection display system;

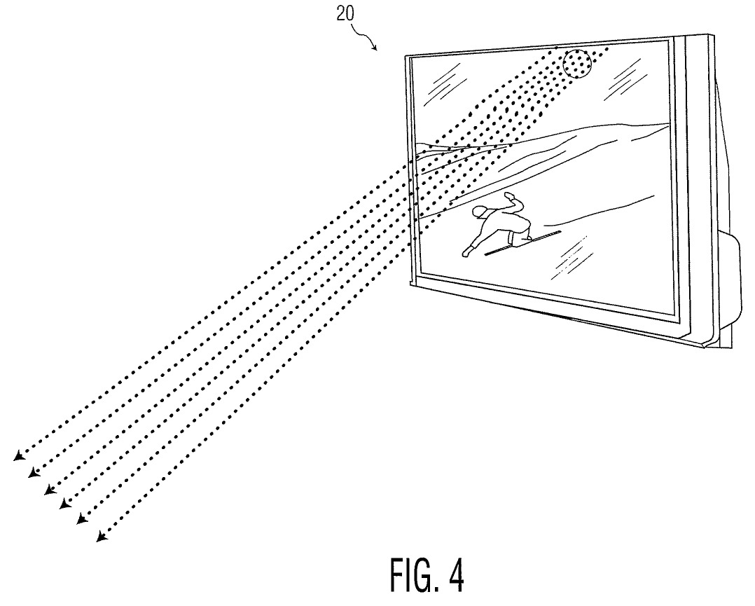

FIG. 4 illustrates an exemplary image display and sunlight simulation by a rear projection screen based electronic window in accordance with the present invention;

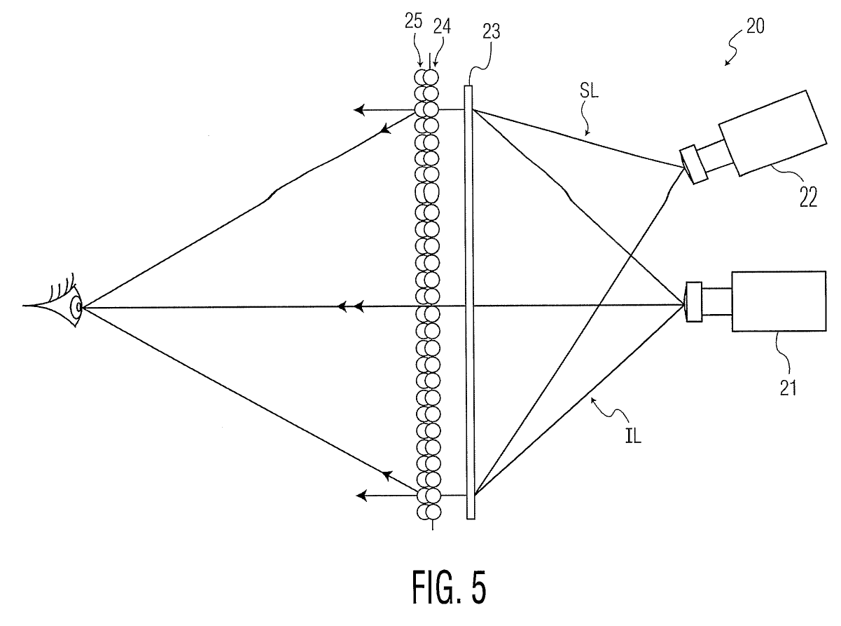

FIG. 5 illustrates one embodiment of an electronic window in accordance with the present invention;

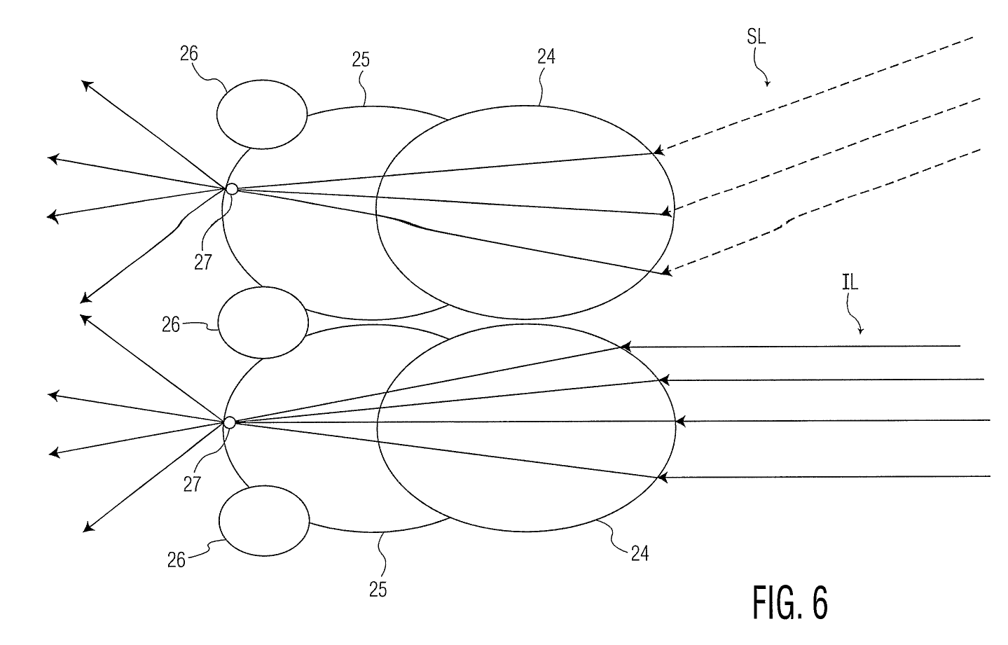

FIG. 6 illustrates a first exemplary image diffusion and simulated sunlight diffusion by a first embodiment of a lenticular screen of the FIG. 5 electronic window;

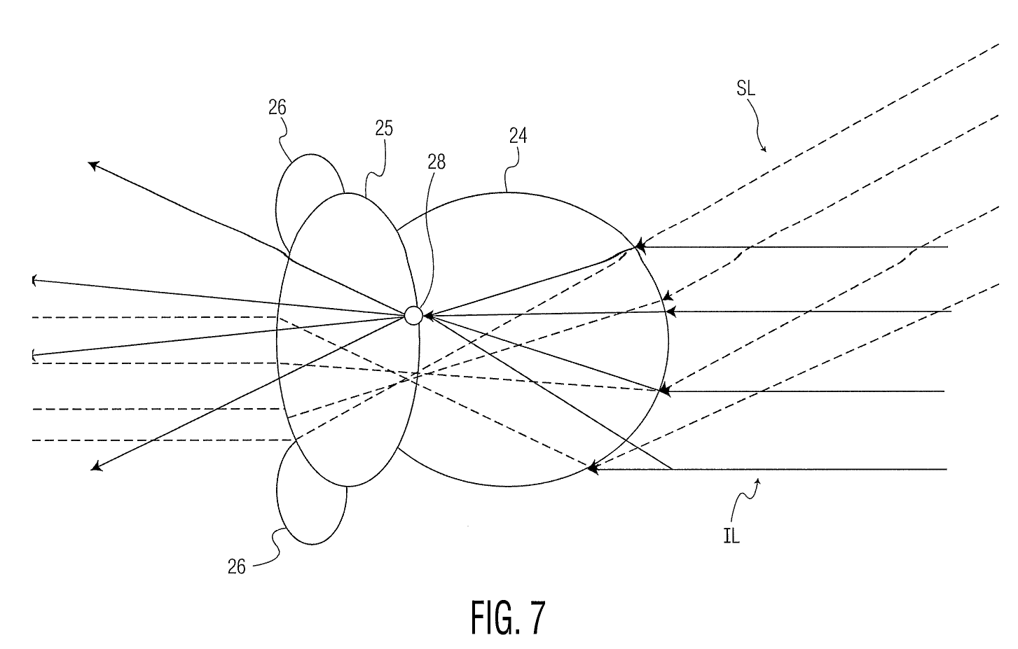

FIG. 7 illustrates a second exemplary image diffusion and simulated sunlight collimation by a second embodiment of a lenticular screen of the FIG. 5 electronic window; and

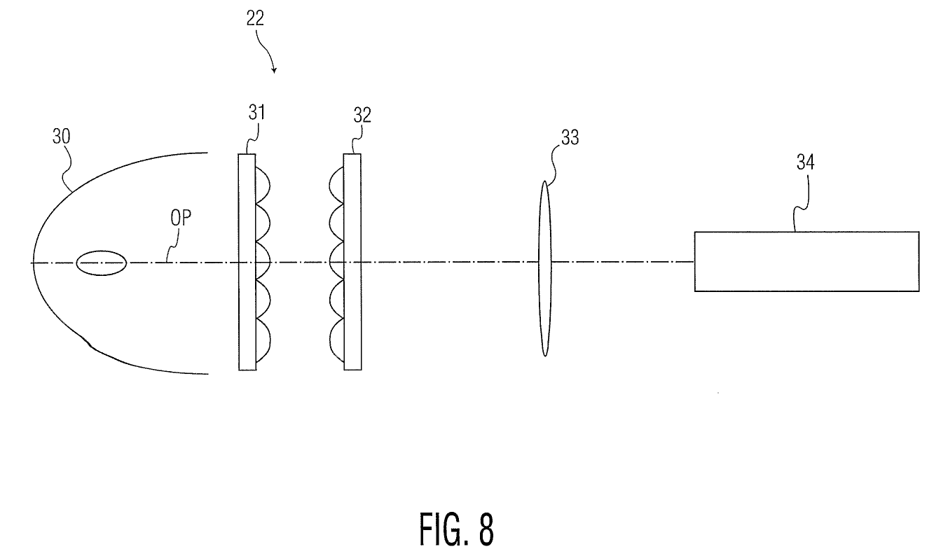

FIG. 8 illustrates one embodiment of a solar simulator in accordance with the present invention.

One inventive principle of the present invention is to structurally incorporate a solar simulator in a rear projection display system to project an artificial sunlight onto a rear projection screen to simulate a sunbeam shining through the rear projection screen into an environmental setting.

A second inventive principle of the present invention is to structurally configure a rear projection screen to include conventional pairings of light-incident-side lenticular lens and light-emitting lenticular lens (e.g., lens 13 and lens 14 shown in FIGS. 1 and 2, respectively) whereby both an image on the rear projection screen and the simulated sunbeam shining through the rear projection screen are optimally distributed within the environmental setting.

A third inventive principle of the present invention is to structurally configure a rear projection screen to include new and unique pairings of light-incident-side lenticular lens and light-emitting lenticular lens whereby an image on the rear projection screen is optimally distributed within the environmental setting while the simulated sunbeam shining through the rear projection screen is substantially collimated within the environmental setting.

In practice, the actual structural configurations of an electronic window in accordance with the present invention is dependent upon commercial implementations of the present invention, and are therefore without limit. The following descriptions of FIGS. 4-8 provide exemplary embodiments of the present invention incorporating one or more of the aforementioned inventive principles of the present invention.

FIG. 4 illustrates an exemplary image projection and a sunbeam simulation by rear projection display system 20 of the present invention. As illustrated in FIG. 5, system 20 employs rear projection engine 21, a solar simulator 22 and a rear projection screen defined by a Fresnel lens 23, a light-incident lenticular lens 24, and a light emitting lenticular lens 25. Lens 24 and 25 are p aired whereby each pair share the same optical axis. In operation, image light IL projected by engine 21 and artificial sunlight SL projected by solar simulator 22 are incident onto Fresnel Lens 23, which collimates image light IL and artificial sunlight SL in a direction of lens 24. The angles of incidences of image light IL and artificial sunlight SL onto lens 24 may or may not be identical.

In one embodiment, as taught in FIG. 6, lens 25 conventionally includes a plurality of light diffusers 27 scattered throughout lens 25 (only two are shown for clarity purposes) whereby lens 24 and lens 25 focus the image light IL and artificial sunlight SL toward the light diffusers 27 to thereby optimally distribute within an environmental setting an image projected on the rear projection screen via image light IL and a simulated sunbeam via artificial sunlight SL shining through the rear projection screen. Those having ordinary skill in the art will appreciate the fact that FIG. 6 is only intended to provide a simple teaching of the distribution of image light IL and artificial sunlight SL by showing separate optical paths for lens 24 and 25, and that in practice, lights IL and SL concurrently pass through lens 24 and 25. Lens 25 conventionally includes black stripe s 26 to minimize, if not eliminate, any reflection of ambient light reflecting upon the rear projection screen. Openings in the rear projection screen established by black stripes 26 can be wider than normal to enable a reasonable degree of reflection of ambient light on the rear projection screen (e.g., 8%) to thereby mimic the properties of a true window.

In a second embodiment, as taught in FIG. 7, lens 25 conventionally includes a plurality of light diffusers 28 (only one is shown for clarity purposes) where each light diffuser 28 has a longitudinal axis that is perpendicular to the optical axes of lens 24 and 25. Light diffusers 28 are advantageously arranged within lens 25 whereby lens 24 exclusively focuses the image light IL toward one of the light diffusers 28 as shown to thereby enable lens 25 to optimally distribute within an environmental setting an image projected on the rear projection screen via image light IL and whereby lens 24 focuses artificial sunlight SL away from light diffusers 28 to thereby enable lens 25 to transform artificial sunlight SL into parallel beams whereby a simulated sunbeam shines through the rear projection screen into the environmental setting. Again, lens 25 conventionally includes black stripes 26 to minimize, if not eliminate, any reflection of ambient light reflecting upon the rear projection screen.

Preferably, the rear projection screen will have a rectangular window and solar simulator 22 will have a conventional projection lens for forming artificial sunlight SL in a homogenous rectangular shape with the same aspect ratio of the rectangular window of the rear projection screen. In one embodiment, solar simulator 22 employs LEDs having a light emitting surface with the same aspect ratio as the rear projection screen. In a second embodiment, solar simulator 22 uses a set of integrator plates having lens positioned in a rectangular window having the same screen aspect ratio of the rear projection screen. In a third embodiment, as illustrated in FIG. 8, solar simulator 22 employs a lamp 30, a pair of plate integrators 31 and 32, a field lens 33, and rod integrator 34 sequentially positioned along an optical path OP to define a rectangular window having the same screen aspect ratio of the rear projection screen.

From the preceding description of the present invention, those having ordinary skill in the art will appreciate various advantages of the present invention. For example, an electronic window of the present invention can be build in a wall of a dimly lit room (e.g., a hospital room, a hotel room, an indoor shop, a work cubical, etc.) whereby a simulated sunbeam can be projected into the room to illuminate the room.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. An electronic window (20), comprising:
a rear projection screen;
a rear projection engine (21) positioned at a first location relative to the rear projection screen wherein the rear projection engine (21) projects an image onto the rear projection screen within an environmental setting; and
a solar simulator (22) positioned at a second location relative to the rear projection screen wherein the solar simulator (22) simulating a sunbeam shining through the rear projection screen into the environmental setting.

2. The electronic window (20) of claim 1,
wherein the rear projection screen includes a Fresnel lens (23); and
wherein an image light (IL) projected by the rear projection engine (21) is incident onto the Fresnel lens (23).

3. The electronic window (20) of claim 2,
wherein the rear projection screen further includes a lenticular screen positioned relative to the Fresnel lens (23) whereby the Fresnel lens (23) collimates the image light (IL) in a direction of the lenticular screen.

4. The electronic window (20) of claim 3,
wherein the lenticular screen includes a light-incident lenticular lens (24) and a light-emitting lenticular lens (25) paring for optimally distributing the image light (IL) within the environmental setting.

5. The electronic window (20) of claim 4, wherein the rear projection screen includes means (26) for minimizing any reflection of ambient light on the rear projection screen.

6. The electronic window (20) of claim 1,
wherein the rear projection screen includes a Fresnel lens (23); and
wherein an artificial sunlight (SL) projected by the solar simulator (22) is incident onto the Fresnel lens (23).

7. The electronic window (20) of claim 6,
wherein the lenticular screen includes a light-incident lenticular lens (24) and a light-emitting lenticular lens (25) paring for optimally distributing the artificial sunlight (SL) within the environmental setting.

8. The electronic window (20) of claim 7, wherein the rear projection screen includes means (26) for minimizing any reflection of ambient light on the rear projection screen.

9. The electronic window (20) of claim 6,
wherein the lenticular screen includes a light-incident lenticular lens (24) and a light-emitting lenticular lens (25) paring for transforming the artificial sunlight (SL) into parallel beams shining through the rear projection screen into the environmental setting.

10. The electronic window (20) of claim 9, wherein the rear projection screen includes means (26) for minimizing any reflection of ambient light on the rear projection screen.

11. An electronic window (20), comprising:
a rear projection screen including a Fresnel lens (23);
a rear projection engine (21) positioned at a first location relative to the rear projection screen wherein an image light (IL) projected by the rear projection engine (21) is incident onto the Fresnel lens (23); and
a solar simulator (22) positioned at a second location relative to the rear projection screen wherein an artificial sunlight (SL) projected by the solar simulator (22) is incident onto the Fresnel lens (23).

12. The electronic window (20) of claim 11,
wherein the rear projection screen further includes a lenticular screen positioned relative to the Fresnel lens (23) whereby the Fresnel lens (23) collimates the image light (IL) and the artificial sunlight (SL) in a direction of the lenticular screen.

13. The electronic window (20) of claim 12,
wherein the lenticular screen includes a light-incident lenticular lens (24) and a light-emitting lenticular lens (25) paring for optimally distributing the image light (IL) within the environmental setting.

14. The electronic window (20) of claim 13, wherein the rear projection screen includes means (26) for minimizing any reflection of ambient light on the rear projection screen.

15. The electronic window (20) of claim 12,
wherein the lenticular screen includes a light-incident lenticular lens (24) and a light-emitting lenticular lens (25) paring for optimally distributing the artificial sunlight (SL) within the environmental setting.

16. The electronic window (20) of claim 15, wherein the rear projection screen includes means (26) for minimizing any reflection of ambient light on the rear projection screen.

17. The electronic window (20) of claim 12,
wherein the lenticular screen includes a light-incident lenticular lens (24) and a light -emitting lenticular lens (25) paring for transforming the artificial sunlight (SL) into parallel beams shining through the rear projection screen into the environmental setting.

18. The electronic window (20) of claim 17, wherein the rear projection screen includes means (26) for minimizing any reflection of ambient light on the rear projection screen.

19. An electronic window (20), comprising:
a rear projection screen;
image means (21, 24, 25) for projecting an image onto the rear projection screen within an environmental setting; and
sunlight simulating means (22, 24, 25) for simulating a sunbeam shining through the rear projection screen into the environmental setting.

20. The electronic window (20) of claim 19, wherein the rear projection screen further includes means (26) for minimizing any reflection of ambient light on the rear projection screen.

21. An electronic window (20), comprising:
a rear projection screen including a lenticular screen (24, 25) including at least one light diffuser (28);
a rear projection engine (21) positioned at a first location relative to the rear projection screen wherein the lenticular screen (24, 25) focuses an image light (IL) projected by the rear projection engine (21) onto one of the at least one light diffuser (28) whereby an image projected by the rear projection screen is distributed within an environmental setting; and
a solar simulator (22) positioned at a second location relative to the rear projection screen wherein the lenticular screen (24, 25) focuses an artificial sunlight (SL) projected by the solar simulator (22) away from the at least one light diffuser (28) whereby the artificial sunlight (SL) is transformed into parallel beam that shine show the rear projection screen into the environmental setting.
